(19) United States
(12) Patent Application Publication
(10) Pub. No.: US 2022/0077669 A1
(43) Pub. Date: Mar. 10, 2022

(54) ELECTRICAL JUNCTION BOX

(71) Applicant: Sumitomo Wiring Systems, Ltd., Yokkaichi-shi, Mie (JP)

(72) Inventors: Ryoma Hamada, Yokkaichi-shi, Mie (JP); Akihiro Oda, Yokkaichi-shi, Mie (JP); Masakazu Okumura, Yokkaichi-shi, Mie (JP); Tatsuya Daidoji, Yokkaichi-shi, Mie (JP); Noriko Okamoto, Yokkaichi-shi, Mie (JP)

(73) Assignee: Sumitomo Wiring Systems, Ltd., Yokkaichi-shi, Mie (JP)

(21) Appl. No.: 17/311,592

(22) PCT Filed: Dec. 3, 2019
(86) PCT No.: PCT/JP2019/047153

§ 371 Date: Jun. 7, 2021

(30) Foreign Application Priority Data
Dec. 7, 2018 (JP) 2018-230279

(51) Int. Cl. H02G 3/16; H01H 85/56; B60R 16/023

(52) U.S. Cl. CPC H02G 3/16; B60R 16/0239; H01H 85/56

(57) ABSTRACT

Provided is an electrical junction box for use in a vehicle that includes: a fit-in housing in which a plurality of fuses are fitted from one side; and a plurality of fuse terminals that connect the fuses fitted in the fit-in housing to a substrate, the electrical junction box comprising a holding body that is plate-shaped, is arranged so as to be opposed to an opposite surface of the fit-in housing that is opposite to the one side, and holds one-end portions of the fuse terminals that are close to the fit-in housing. The remaining portions of the fuse terminals other than the one-end portions are not held and are released.

### CROSS-REFERENCE TO RELATED APPLICATIONS

This application is the U.S. national stage of PCT/JP2019/047153 filed on Dec. 3, 2019, which claims priority of Japanese Patent Application No. JP 2018-230279 filed on Dec. 7, 2018, the contents of which are incorporated herein.

### TECHNICAL FIELD

The present disclosure relates to an electrical junction box that is used in vehicles.

### BACKGROUND

JPH09-283004A discloses an electrical junction box provided with a box body that includes: a plurality of fuse fitting portions to which fuses are fitted; a plurality of fusible link fitting portions to which fusible links are fitted; and a main fusible link fitting portion to which a main fusible link is fitted, wherein the fuse fitting portions, the fusible link fitting portions, and the main fusible link fitting portion are sequentially arranged in that order on a surface of the box body.

Typically, in a process for manufacturing an electrical junction box, a reflow method is used when a substrate is soldered. In the reflow method, the soldering is performed using hot air in a reflow furnace.

Meanwhile, in the electrical junction box, a fuse module in which fuses are fitted and a substrate are connected to each other with fuse terminals, and such fuse terminals are held by a holding body.

However, the conventional electrical junction box has a configuration in which the holding body holds the fuses in a state of covering substantially the entirety of the fuse terminals. In such a conventional electrical junction box, the holding body shields against flows of hot air, and therefore hot air does not directly reach the substrate, causing a problem in which appropriate soldering cannot be performed on the substrate.

However, the electrical junction box of JPH09-283004A does not address such a problem, and cannot solve the problem.

Therefore, it is an object of the present disclosure to provide an electrical junction box for which appropriate soldering is possible in a manufacturing process.

### SUMMARY

The electrical junction box according to an aspect of the present disclosure relates to an electrical junction box for use in a vehicle that includes: a fit-in housing in which a plurality of fuses are fitted from one side; and a plurality of fuse terminals that connect the fuses fitted in the fit-in housing to a substrate, the electrical junction box including, a holding body that is plate-shaped, is arranged so as to be opposed to an opposite surface of the fit-in housing that is opposite to the one side, and holds one-end portions of the fuse terminals that are close to the fit-in housing, wherein the remaining portions of the fuse terminals other than the one-end portions are not held and are released.

### Advantageous Effects of Present Disclosure

According to an aspect of the present disclosure, it is possible to provide an electrical junction box for which appropriate soldering is possible in a manufacturing process.

### BRIEF DESCRIPTION OF DRAWINGS

FIG. 1 is a perspective view illustrating an outer appearance of an electrical junction box according to the present embodiment.

FIG. 2 is a perspective view illustrating the electrical junction box according to the present embodiment in a state in which a case member and a cap member are omitted.

FIG. 3 is a perspective view illustrating the rear side of a fuse module of the electrical junction box according to the present embodiment.

FIG. 4 is an exploded view of the fuse module of the electrical junction box according to the present embodiment.

FIG. 5 is an exploded view of the fuse module of the electrical junction box according to the present embodiment.

FIG. 6 is a vertical cross-sectional view taken along a line VI-VI in FIG. 3.

FIG. 7 is a perspective view illustrating an upper case portion of the electrical junction box according to the present embodiment.

### DETAILED DESCRIPTION OF PREFERRED EMBODIMENTS

First, embodiments of the present disclosure will be listed and described. At least some of the embodiments described below may also be suitably combined with each other.

The electrical junction box according to an aspect of the present disclosure relates to an electrical junction box for use in a vehicle that includes: a fit-in housing in which a plurality of fuses are fitted from one side; and a plurality of fuse terminals that connect the fuses fitted in the fit-in housing to a substrate, the electrical junction box including, a holding body that is plate-shaped, is arranged so as to be opposed to an opposite surface of the fit-in housing that is opposite to the one side, and holds one-end portions of the fuse terminals that are close to the fit-in housing, wherein the remaining portions of the fuse terminals other than the one-end portions are not held and are released.

According to this aspect, the holding body is plate-shaped, and holds only the one-end portions of the fuse terminals that are close to the fit-in housing. Accordingly, the remaining portions of the fuse terminals other than the one-end portions are not held by the holding body and are released. Accordingly, in a manufacturing process of the electrical junction box, hot air directly reaches the substrate, and thus appropriate soldering is possible.

In the electrical junction box according to an aspect of the present disclosure, the fit-in housing has the shape of a cuboid box, the substrate is arranged on the side of a long side of the opposite surface while extending parallel to a thickness direction of the holding body, and a fastening portion for fixing the holding body to the substrate is provided.

According to this aspect, the holding body includes the fastening portion for fixing the holding body to the substrate. Accordingly, the holding body is reliably fixed, and the fuse terminals can be reliably held even if the holding body holds only the one-end portions of the fuse terminals.

The electrical junction box according to an aspect of the present disclosure further includes: a locking portion that is provided on the holding body, and is used to attach the holding body to the fit-in housing; and a lock hole that is formed in the fit-in housing, and corresponds to the locking portion.

According to this aspect, as a result of the locking portion provided on the holding body being hooked and locked in the lock hole formed in the fit-in housing, the holding body is attached to the fit-in housing. Accordingly, the holding body is reliably fixed, and the fuse terminals can be reliably held even if the holding body holds only the one-end portions of the fuse terminals.

The electrical junction box according to an aspect of the present disclosure further includes: a holding plate portion that holds the holding body from a first surface side of the holding body that is opposed to the opposite surface of the fit-in housing.

According to this aspect, the holding plate portion is provided on the fit-in housing, and holds the holding body from the first surface side of the holding body. Accordingly, the holding body is reliably fixed, and the fuse terminals can be reliably held even if the holding body holds only the one-end portions of the fuse terminals.

The electrical junction box according to an aspect of the present disclosure further includes: a holding piece that holds the holding body from a second surface side of the holding body that is opposite to the first surface.

According to this aspect, the holding piece is provided on the second surface side of the holding body, and holds the holding body. Accordingly, the holding body is reliably fixed, and the fuse terminals can be reliably held even if the holding body holds only the one-end portions of the fuse terminals.

The present disclosure will be described specifically with reference to the drawings showing an embodiment thereof. The following will describe an electrical junction box according to the embodiment of the present disclosure with reference to the drawings. Note that the present disclosure is not limited to these examples but is defined by the claims, and the present disclosure is intended to include all changes within the meaning and scope that are equivalent to the claims.

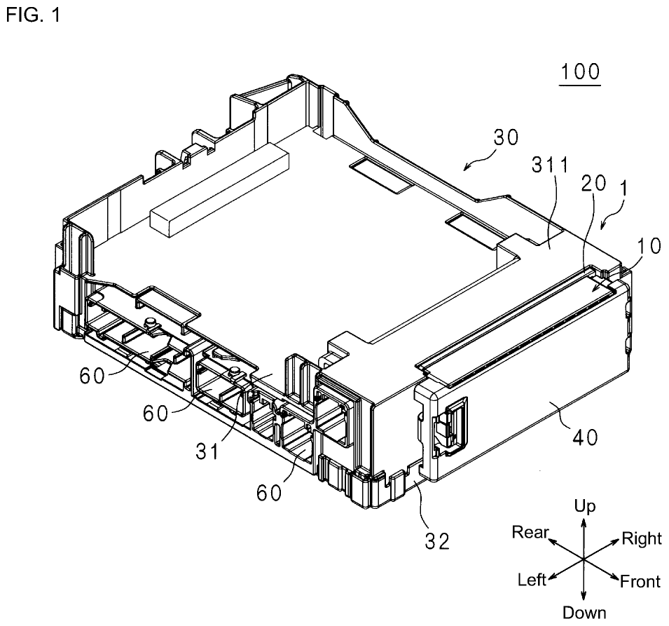

FIG. 1 is a perspective view showing an outer appearance of an electrical junction box 100 according to the present embodiment. The electrical junction box 100 is a so-called fuse box in which fuses are fitted, and is installed in a vehicle.

The electrical junction box 100 includes a case member 30 that houses a substrate on which electronic components and the like are mounted, a fuse module 1 in which fuses are fitted, and a cap member 40 that covers an opening of the fuse module 1.

In the present embodiment, for convenience, “front”, “rear”, “left”, “right”, “up”, and “down” of the electrical junction box 100 are defined based on a front-rear direction, a left-right direction, and an up-down direction that are shown in FIG. 1. The following description will be given using the front-rear direction, the left-right direction, and the up-down direction thus defined.

The case member 30 includes an upper case portion 31, and a lower case portion 32. The upper case portion 31 has a step such that the size of the front end portion thereof in the up-down direction is larger than the size of the remaining portion. The upper case portion 31 includes a flat plate portion 311 in the front end portion, and the plate portion 311 covers a plurality of fuse terminals 13, which will be described later. Note that a plurality of connector terminals 60 are provided on the left and right side surfaces of the electrical junction box 100.

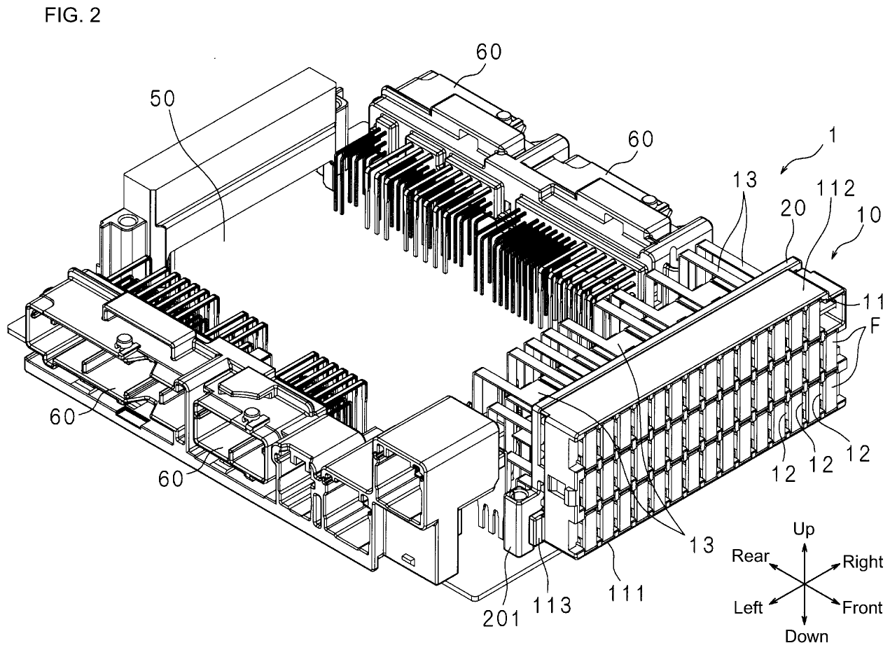

FIG. 2 is a perspective view of the electrical junction box 100 according to the present embodiment in a state in which the case member 30 and the cap member 40 are omitted.

The fuse module 1 includes a fit-in housing 10 in which a plurality of fuses F are fitted, a plurality of fuse terminals 13 that connect the fuses F fitted in the fit-in housing 10 and a substrate 50, and a holding body 20 that holds the fuse terminals 13.

The fit-in housing 10 has the shape of a cuboid box of which the entire front side is open. The fit-in housing 10 has rectangular insertion holes 12 therein in which the fuses F are fitted, the rectangular insertion holes 12 being provided in a matrix. That is to say, the insertion holes 12 are exposed via an opening 11 formed on the front side of the fit-in housing 10.

The substrate 50 is arranged below the fit-in housing 10. Specifically, the substrate 50 is provided in the vicinity of a lower-side wall portion 111, which is located on the lower side, out of four wall portions of the fit-in housing 10 that are adjacent to the opening 11. The substrate 50 is distanced from the outer surface of the lower-side wall portion 111, and is arranged in parallel to the lower-side wall portion 111. The fuses F inserted into the insertion holes 12 are connected to the substrate 50 by the fuse terminals 13.

The opening 11 is rectangular, and the plurality of insertion holes 12 are aligned in lines in the long-side direction (left-right direction) of the opening 11. For example, lines of the insertion holes 12 aligned in the long-side direction of the opening 11 are arranged in three rows in the short-side direction (up-down direction) of the opening 11.

In each of the lines of the insertion holes 12, the insertion holes 12 are aligned in the long-side direction of the opening 11 so that the long-side direction of each insertion hole 12 is parallel to the short-side direction (up-down direction) of the opening 11.

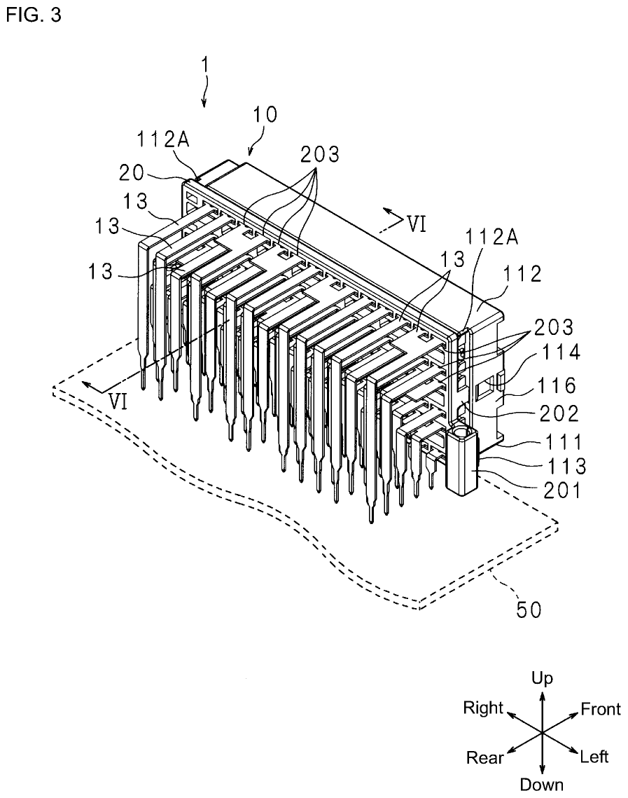

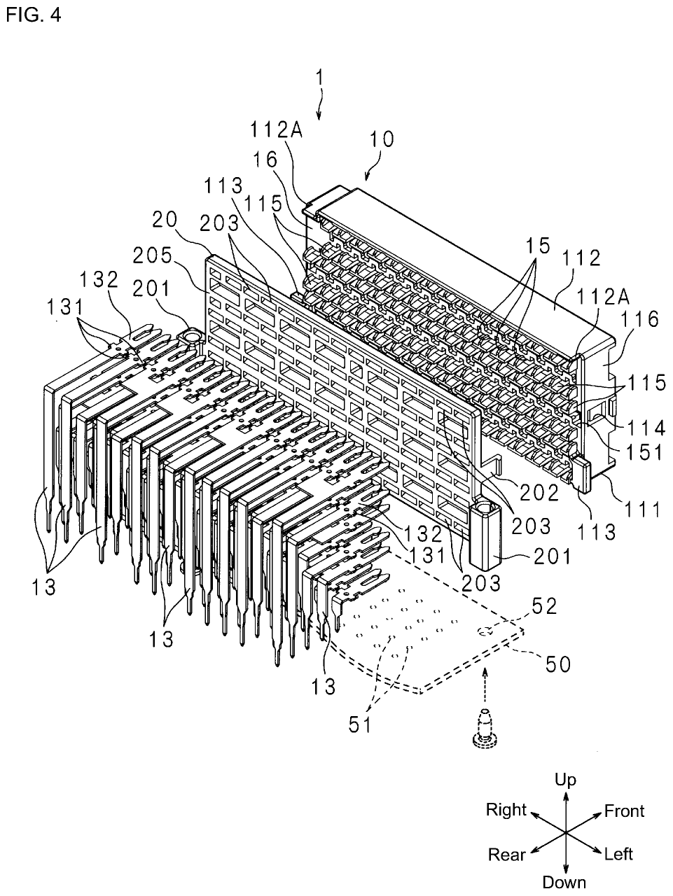

FIG. 3 is a perspective view showing the rear side of the fuse module 1 of the electrical junction box 100 according to the present embodiment, and FIG. 4 is an exploded view of the fuse module 1 of the electrical junction box 100 according to the present embodiment. The exploded view in FIG. 4 shows the fuse module 1 from the rear side. Also, for convenience of description, the substrate 50 is shown in dotted lines in FIGS. 3 and 4.

A rear surface 16 (opposite surface) of the fit-in housing 10 has a plurality of through-holes 15 for insertion of one-end portions 132 of the fuse terminals 13. The one-end portions 132 of the fuse terminals 13 are inserted into the fit-in housing 10 via the through-holes 15.

The rear surface 16 also has, in the vicinity of the through-holes 15, guide portions 115 for guiding the insertion of the fuse terminals 13 into the through-holes 15. The guide portions 115 substantially has a gutter shape, and protrude from the rear surface 16 toward the holding body 20. The plurality of guide portions 115 are aligned along the long-side direction of the rear surface 16. Accordingly, during an operation for assembling the electrical junction box 100, an operator can use the guide portions 115 to easily insert the one-end portions 132 of the fuse terminals 13 into the through-holes 15.

The fuse terminals 13 are made of a thin conductive metal sheet material. Each of the fuse terminals 13 has a bent portion in a middle portion thereof, and is substantially L-shaped, for example. As described above, the one-end portions 132 of the fuse terminals 13 are inserted into the through-holes 15 formed in the rear surface 16. The one-end portions 132 of some of the plurality of fuse terminals 13 are divided into two parts. The one-end portions 132 of the fuse terminals 13 are connected to the fuses F fitted in the fit-in housing 10. Also, the other-end portions of the fuse terminals 13 are oriented downward, that is, to the substrate 50, are inserted into through-holes 51 of the substrate 50, and are connected to the substrate 50 by, for example, soldering.

The fuse terminals 13 are provided such that the side surfaces thereof adjacent to the main surfaces having the large area are oriented leftward or rightward. In other words, each fuse terminal 13 is provided such that the thickness direction of a portion thereof located on one side of the bent portion, and the thickness direction of a portion located on the other side intersect with each other.

Also, the fit-in housing 10 has lock holes 114 that are used to attach the holding body 20 to the fit-in housing 10. The lock holes 114 are formed at positions that correspond to later-described locking portions 202 of the holding body 20.

The lock holes 114 are formed in left and right-side wall portions 116 of the fit-in housing 10 that are adjacent to the lower-side wall portion 111. The lock holes 114 are rectangular holes, and are through-holes that penetrate the respective wall portions 116 of the fit-in housing 10 from the inside to the outside. In the rear surface 16, guide holes 151 for guiding the insertion of the locking portions 202 of the holding body 20 are formed in rim portions adjacent to the respective left and right-side wall portions 116, that is, in the vicinity of the lock holes 114.

Accordingly, during an operation for assembling the electrical junction box 100, the operator can attach the holding body 20 to the fit-in housing 10, by inserting the locking portions 202 of the holding body 20 into the guide holes 151 of the fit-in housing 10 and hooking and locking the locking portions 202 into the lock holes 114.

Furthermore, the fit-in housing 10 has notches 112A formed in an upper side wall portion 112, which is opposed to the lower-side wall portion 111. The upper-side wall portion 112 is strip-shaped, and the notches 112A are respectively formed at two rear-side corners, out of the four corners of the upper-side wall portion 112.

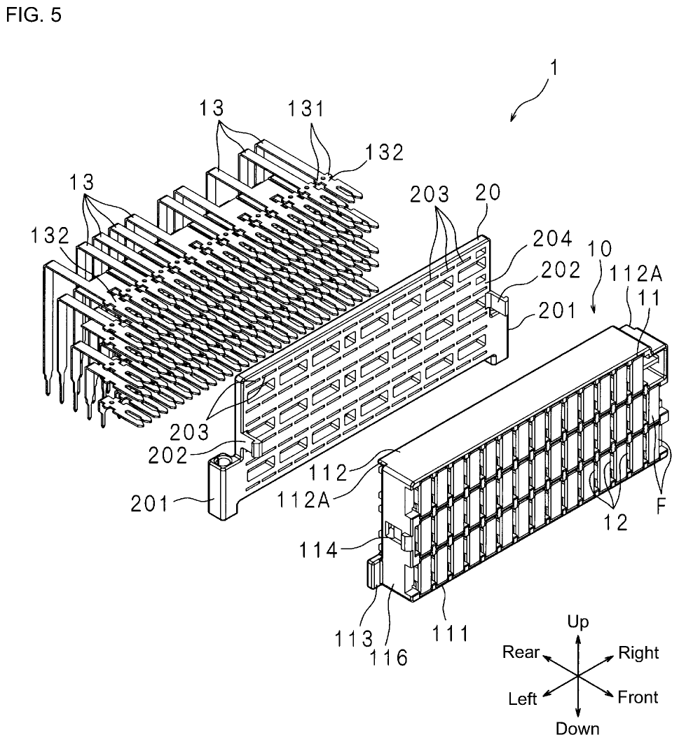

FIG. 5 is an exploded view of the fuse module 1 of the electrical junction box 100 according to the present embodiment. The exploded view in FIG. 5 shows the fuse module 1 from the front side. Also, for convenience of description, the substrate 50 is omitted from FIG. 5.

Furthermore, in the fit-in housing 10, the left and right-side wall portions 116 respectively include holding plate portions 113 for holding the holding body 20. The holding plate portions 113 have the shape of a rectangular plate, and protrude from the rear rims of the left and right-side wall portions 116 of the fit-in housing 10 in a direction that intersects with the wall portions 116. The holding plate portions 113 are provided in the lower end portion of the rear rims of the wall portions 116, and abut against later-described screw fastening tubes 201 (fastening portion) of the holding body 20, thereby holding the holding body 20. That is to say, the holding plate portions 113 hold the holding body 20 from a first surface 204 side of the holding body 20 that is opposed to the rear surface 16 of the fit-in housing 10.

The holding body 20 has the shape of a rectangular plate having a predetermined thickness, and is arranged so that the first surface 204 is opposed to the rear surface 16 of the fit-in housing 10. The holding body 20 is made of an insulating plastic or the like, and holds the fuse terminals 13. Specifically, the holding body 20 holds only the one-end portions 132 of the plurality of fuse terminals 13 that are close to the fit-in housing 10.

The holding body 20 includes a plurality of insertion through-holes 203 that penetrate the holding body 20 in the thickness direction thereof. The number of insertion through-holes 203 corresponds to the number of the plurality of fuse terminals 13, and the insertion through-holes 203 are formed at positions that correspond to the one-end portions 132 of the fuse terminals 13. That is to say, the insertion through-holes 203 are aligned in the long-side direction of the holding body 20.

During an operation for assembling the electrical junction box 100, the one-end portions 132 of the fuse terminals 13 are inserted through the insertion through-holes 203. That is to say, the one-end portions 132 of the fuse terminals 13 are inserted into the through-holes 15 of the fit-in housing 10 via the insertion through-holes 203.

On the other hand, the one-end portion 132 of each of the fuse terminals 13 has, on the side surfaces thereof, retaining portions 131 that locally protrude along the main surfaces. As a result of the retaining portions 131 being pressed into the insertion through-hole 203, the one-end portion 132 of the fuse terminal 13 can be prevented from being removed from the through-hole 15 of the fit-in housing 10.

As a result of the holding body 20 holding only the one-end portions 132 of the plurality of fuse terminals 13 in this way, the remaining portions of the fuse terminals 13 other than the one-end portions 132 are not held and are released.

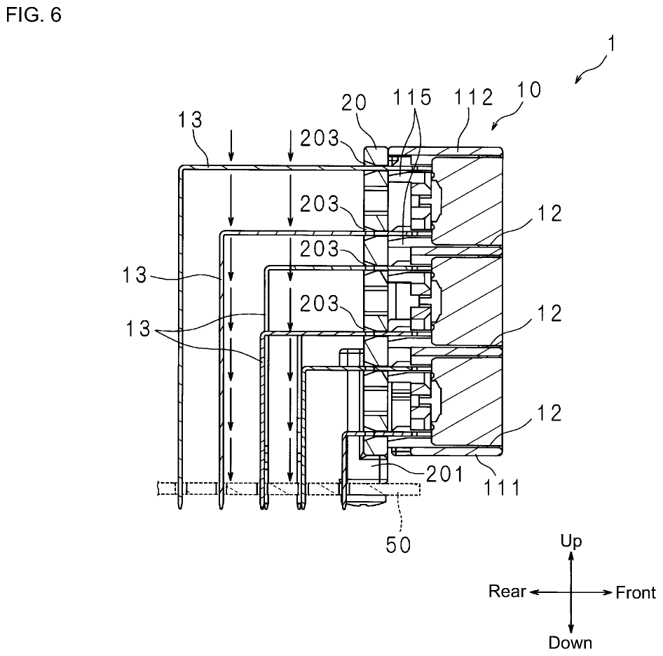

FIG. 6 is a vertical cross-sectional view taken along a line VI-VI in FIG. 3. As shown in FIG. 6, the remaining portions of the fuse terminals 13 other than the one-end portions 132 are exposed.

Accordingly, when, during an operation for assembling the electrical junction box 100, a reflow method is used to solder the other-end portions of the fuse terminals 13 to the substrate 50, a flow of hot air (indicated by arrows in FIG. 6) directly reaches the substrate 50 without being blocked.

In a typical reflow furnace, hot air flows in the up-down direction. Accordingly, in a conventional configuration in which the holding body 20 holds the fuse terminals 13 in a state of covering substantially the entirety of the fuse terminals 13, a flow of hot air is shielded by the holding body 20. Accordingly, the hot air does not directly reach the substrate 50, causing a problem in which appropriate soldering is impossible.

In contrast, in the electrical junction box 100 according to the present embodiment, the remaining portions of the fuse terminals 13 other than the one-end portions 132 are exposed, and thus when a reflow method is used to solder the other-end portions of the fuse terminals 13 to the substrate 50, hot air directly reaches the substrate 50 without being blocked by the holding body 20. This makes it possible to realize appropriate soldering.

Also, the holding body 20 includes, on the first surface 204 opposed to the rear surface 16 of the fit-in housing 10, the locking portions 202 for attaching the holding body 20 to the fit-in housing 10. The locking portions 202 are substantially hook-shaped. The locking portions 202 protrude from the rims of the two short sides of the rectangular first surface 204 in a direction that intersects with the first surface 204.

As described above, the locking portions 202 of the holding body 20 are inserted into the guide holes 151 of the fit-in housing 10 so as to be hooked and locked in the lock holes 114. At this time, out of the long-side surfaces of the first surface 204, the upper-side surface is coplanar with the outer surface of the upper-side wall portion 112 of the fit-in housing 10, and the lower-side surface is coplanar with the outer surface of the lower-side wall portion 111 of the fit-in housing 10.

In this way, as a result of the holding body 20 being fixed to the fit-in housing 10, only the one-end portions 132 of the plurality of fuse terminals 13 can be held appropriately.

Furthermore, the holding body 20 has, on both short-side surfaces of the first surface 204, the screw fastening tubes 201 for use to fix the holding body 20 to the substrate 50. The screw fastening tubes 201 have the shape of a square tube extending in the up-down direction, and have a screw hole therein. The screw fastening tubes 201 are provided so that one of the outer side surfaces of each screw fastening tube 201 is coplanar with the first surface 204.

Screw through-holes 52 are formed in the substrate 50 at positions that correspond to the screw fastening tubes 201. Accordingly, during an operation for assembling the electrical junction box 100, when screws are inserted through the screw through-holes 52 and are screwed to the screw holes of the screw fastening tubes 201, the holding body 20 is fixed to the substrate 50. At this time, the holding body 20 is fixed in a state of being distanced from the substrate 50.

Note that the holding plate portions 113 of the fit-in housing 10 abut against these one outer side surfaces of the screw fastening tubes 201 of the holding body 20. The holding body 20 is reliably held due to the abutment of the screw fastening tubes 201 against the holding plate portions 113, in addition to the hooking and locking between the locking portions 202 and the lock holes 114.

The present embodiment has described a case in which screws are screwed to the screw holes of the screw fastening tubes 201, and the holding body 20 is thereby fixed to the substrate 50, but the present disclosure is not limited thereto. For example, a configuration is also possible in which, instead of the screw fastening tubes 201, pin members whose leading ends have a retaining barb are provided, and the leading ends of the pin members are pressed into the screw through-holes 52 and are coupled to the screw fastening tubes 201, thereby realizing the fixation of the holding body 20 to the substrate 50.

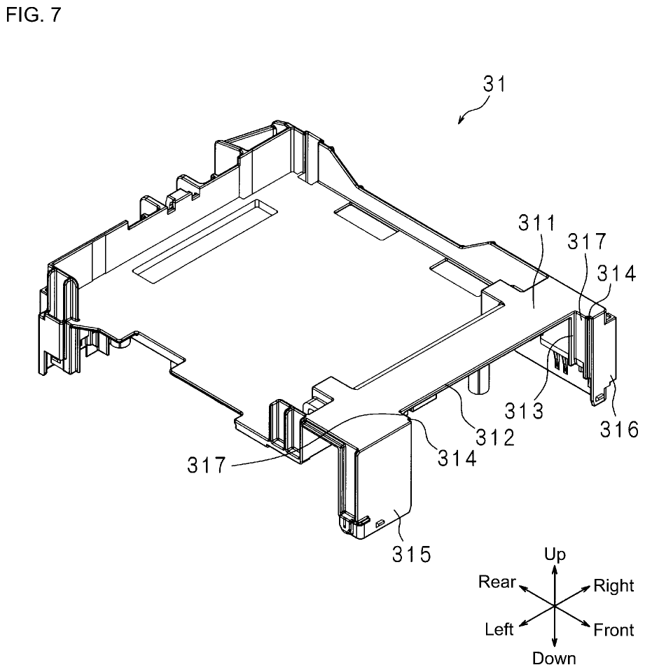

FIG. 7 is a perspective view showing the upper case portion 31 of the electrical junction box 100 according to the present embodiment. As described above, the upper case portion 31 includes the plate portion 311 in the front end portion thereof. Also, the plate portion 311 has a notch 312 in substantially the center of the edge on the front side thereof. The notch 312 is strip-shaped such that the long-side direction of the notch 312 corresponds to the direction along the edge.

The rear portions of the holding body 20 and the fit-in housing 10 are arranged on the inner side of the notch 312 (see FIG. 1). That is to say, the size of the notch 312 in the long-side direction is substantially equal to the size of the holding body 20 in the long-side direction, and the size of the notch 312 in the short-side direction is larger than the thickness of the holding body 20.

Front plate portions 315 and 316 protrude from the remaining portion of the front edge of the plate portion 311 other than the notch 312, that is, from the portions on the left and right side of the notch 312, the front plate portions 315 and 316 protruding in a direction that intersects with the plate portion 311. The fit-in housing 10 is arranged between the front plate portions 315 and 316 (see FIG. 1). That is to say, the fit-in housing 10 is arranged so that the left and right-side wall portions 116 of the fit-in housing 10 respectively intersect with the front plate portions 315 and 316.

Also, side panel portions 317 protrude from the two short-side edges of the notch 312 in the direction that intersects with the plate portion 311. That is to say, of the two side panel portions 317, the left side panel portion 317 is adjacent to the front plate portion 315, and the right side panel portion 317 is adjacent to the front plate portion 316.

Furthermore, holding pieces 313 protrude from the two end portions of a long-side edge of the notch 312 in the direction that intersects with the plate portion 311. That is to say, the holding pieces 313 respectively intersect with the side panel portions 317, and the holding pieces 313 are provided so as to be adjacent to the respective side panel portion 317.

The side panel portions 317 and the holding pieces 313 are all strip-shaped such that the size thereof in the long-side direction, that is, the up-down direction is smaller than the size of the front plate portions 315 and 316 in the long-side direction. Also, the size of the side panel portions 317 in the short-side direction is larger than the size of the holding pieces 313 in the short-side direction.

If the holding body 20 is arranged on the inner side of the notch 312, the side panel portions 317 abut against the short-side surfaces of the holding body 20 (first surface 204). In other words, the holding body 20 is interposed between and held by the side panel portions 317. At this time, the holding pieces 313 abut against a second surface 205 of the holding body 20 that is opposite to the first surface 204. That is to say, the two holding pieces 313 hold the holding body 20 from the second surface 205 side.

As already described, the holding body 20 is held by two holding plate portions 113 from the first surface 204 side, and the holding body 20 is also held by two holding pieces 313 from the second surface 205 side as described immediately above. In other words, the holding body 20 is interposed between and held by two holding pieces 313 and two holding plate portions 113.

In the electrical junction box 100 according to the present embodiment, which has such a configuration, the holding body 20 is reliably held. Accordingly, the holding body 20 can also rigidly hold the fuse terminals 13, while holding only the one-end portions 132 of the plurality of fuse terminals 13.

Note that the upper case portion 31 includes positioning portions 314 respectively obtained by cutting off the edge made between the side panel portion 317 and the front plate portion 315, and the edge made between the side panel portion 317 and the front plate portion 316 in the shape of a rectangle. When, during an operation for assembling the electrical junction box 100, the notches 112A of the upper-side wall portions 112 are engaged with the positioning portions 314, the fit-in housing 10 is positioned. Accordingly, the fit-in housing 10 is arranged correctly.

It should be understood that the embodiment disclosed herein is an example in all respects and not restrictive. The scope of the present disclosure is defined by the claims rather than the above-described meaning, and is intended to encompass all modifications within the scope equivalent to the claims.

1. An electrical junction box for use in a vehicle that includes: a fit-in housing in which a plurality of fuses are fitted from one side; and a plurality of fuse terminals that connect the fuses fitted in the fit-in housing to a substrate, the electrical junction box comprising,
a holding body that is plate-shaped, is arranged so as to be opposed to an opposite surface of the fit-in housing that is opposite to the one side, and holds one-end portions of the fuse terminals that are close to the fit-in housing,
wherein the remaining portions of the fuse terminals other than the one-end portions are not held and are released.

2. The electrical junction box according to claim 1,
wherein the fit-in housing has the shape of a cuboid box,
the substrate is arranged on the side of a long side of the opposite surface while extending parallel to a thickness direction of the holding body, and
a fastening portion for fixing the holding body to the substrate is provided.

3. The electrical junction box according to claim 1, further comprising:
a locking portion that is provided on the holding body, and is used to attach the holding body to the fit-in housing; and
a lock hole that is formed in the fit-in housing, and corresponds to the locking portion.

4. The electrical junction box according to claim 1, further comprising
a holding plate portion that holds the holding body from a first surface side of the holding body that is opposed to the opposite surface of the fit-in housing.

5. The electrical junction box according to claim 4, further comprising:
a holding piece that holds the holding body from a second surface side of the holding body that is opposite to the first surface.

6. The electrical junction box according to claim 2, further comprising:
a locking portion that is provided on the holding body, and is used to attach the holding body to the fit-in housing; and
a lock hole that is formed in the fit-in housing, and corresponds to the locking portion.

7. The electrical junction box according to claim 2, further comprising:
a locking portion that is provided on the holding body, and is used to attach the holding body to the fit-in housing; and
a lock hole that is formed in the fit-in housing, and corresponds to the locking portion.

8. The electrical junction box according to claim 2, further comprising
a holding plate portion that holds the holding body from a first surface side of the holding body that is opposed to the opposite surface of the fit-in housing.

9. The electrical junction box according to claim 3, further comprising
a holding plate portion that holds the holding body from a first surface side of the holding body that is opposed to the opposite surface of the fit-in housing.
